(19) United States
(12) Patent Application Publication
(10) Pub. No.: US 2004/0204205 A1
(43) Pub. Date: Oct. 14, 2004

(54) Cable-free programmable radio

(76) Inventor: Paul Goodjohn, Lynchburg, VA (US)

Correspondence Address: Joseph A. Tessari, Tyco Technology Resources, Suite 450, 4550 New Linden Hill Road, Wilmington, DE, 19808-2952, US

(21) Appl. No.: 10/412,837

(22) Filed: Apr. 11, 2003

(51) Int. Cl. H04B 1/38

(52) U.S. Cl. 455/575.1; 455/418; 455/90.1

(57) ABSTRACT

A cable-free programmable radio is described. In one exemplary implementation, a radio includes an infrared port configured to receive programmable information from a host device via an infrared signal. The radio also includes a control system having a selectable programmable mode to enable the radio to download the programmable information from the host device and configure the radio function in accordance with the programmable information. A radio may be configured/reconfigured (such as when “cloning” the radio) by connecting the radio to a host device through the infrared port, wirelessly.

### TECHNICAL FIELD

The present invention relates generally to programming two-way radios.

### BACKGROUND

Police personnel, fire personnel, military personnel, government personnel, commercial organizations, and licensed civilians, typically use high-end two-way radios. Such radios may operate at high power levels and at ultra-high frequencies (UHF), very-high frequencies (VHF), and other frequencies. To ensure that radios used by one group (e.g., a police department) do not interfere with radios used by another group (e.g., a fire department), it may be necessary for the radios to operate on different channels and/or use security features. The security features may include encryption, spread-spectrum techniques, and other related security measures to prevent others from eavesdropping on communications between such radios and/or interfering with their channels of communication.

Most radios include a configurable infrastructure, such as a configurable operating system, that enables them to be configured to operate at specific frequencies and utilize specific security features. To ensure interoperability between radios in a particular group, it is necessary to configure them so they operate identically. One way to configure a radio is through a process called “cloning,” which is a feature that permits one radio (a master) to transfer configuration data to another radio (a slave) via a wired cable interface. This effectively makes a copy, or clone, of the master radio making the master and slave interoperable. Another way to configure a radio is to connect the radio (slave) to a host device (master), such as a computer, using specialized adapters and cables for configuring the radio to operate in accordance with a specific application.

The problem with these approaches is that they tend to require expensive interface equipment and proprietary wire cable interfaces that are often incompatible with radios made by a different manufacturer or even with different radio models manufactured by the same manufacturer. Additionally, interface equipment and proprietary wire cable interfaces may require several electrical interface contacts on the exterior of a radio, which can cause problems when the radio is exposed to water. For instance, if liquid is able to enter a radio chassis through the interface contacts, it may cause the radio's internal parts to be exposed to liquid, which is highly likely to cause the radio to fail. Furthermore, wire cables and interface equipment are bulky making them inconvenient and burdensome to transport into the field.

A recent approach used to solve these problems involves the use of wireless radio frequency links instead of wired links. There are several problems with this approach. For instance, it may take substantially longer to program a radio using a radio frequency link, because the data rate achieved through such a link tends be very low, which is attributed to narrow bandwidths associated with radio frequencies. Additionally, a radio frequency interface is susceptible to interference from other devices, which may cause improper or incomplete receipt of configuration data. Furthermore, a radio frequency interface link is susceptible to eavesdropping making it insecure when compared to a wired link.

### SUMMARY

A cable-free programmable radio is described. In one exemplary implementation, a radio includes an infrared port configured to receive programmable information from a host device via an infrared signal. The radio also includes a control system having a selectable programmable mode to enable the radio to download the programmable information from the host device and configure the radio to function in accordance with the programmable information.

The described implementations, therefore, introduce the broad concept of configuring/reconfiguring a radio (such as when “cloning” a radio) by connecting the radio to a host device through an infrared link, wirelessly. This eliminates the need for physical cable connections between the host device and radio. Additionally, infrared connectivity is generally secure and is not susceptible to radio frequency interference such as may be experienced with a radio frequency based wireless link. Moreover, there is no need for electrical contacts on the chassis of a radio, making it easier to seal the chassis from water.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 is a block diagram illustrating various components of an exemplary two-way radio that can be utilized to implement the inventive techniques described herein.

FIG. 2 is a block diagram illustrating select elements used in a system environment in which a radio operates.

FIG. 3 is a flow chart illustrating an exemplary method for configuring a radio.

### DETAILED DESCRIPTION

Exemplary Radio Architecture

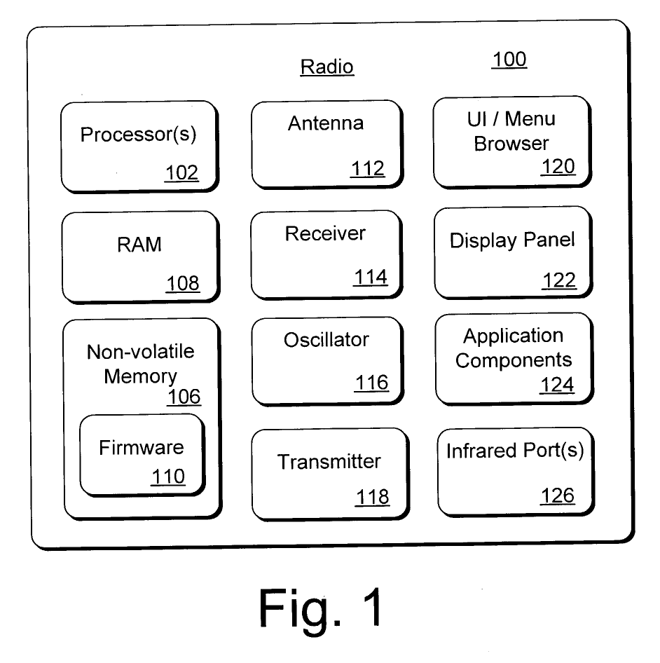

FIG. 1 illustrates various components of an exemplary mobile radio 100 that can be utilized to implement the inventive techniques described herein. Radio 100 may include one or more processors 102. Processor(s) 102 execute various instructions to control the operation of the radio 100 and to communicate with other electronic, computing, and radio devices.

Radio 100 may also include a non-volatile memory 106 (such as Read-Only-Memory (ROM)), and a random access memory (RAM) 108. The memory components, i.e., non-volatile memory 106, and RAM 108, store various information and/or data such as configuration information, radio operating systems, receive or transmit data, and menu structure information. Radio 100 may include a firmware component 110 that is implemented as a permanent memory module stored in non-volatile memory 106. Firmware 110 is programmed and tested like software, and is distributed with radio 100 (or separately, such as in the form of an update). Firmware 110 can be implemented to coordinate operations of the hardware within radio 100 and contains programming constructs used to perform such operations.

Although not shown, a particular radio can also include a flash memory device as non-volatile memory 106 or in addition to non-volatile memory 106 when in the form of a read-only-memory device (ROM). Additionally, although not shown, one or more system busses typically connect the various components within radio 100 including power systems also not shown.

Radio 100 also includes a receiver 114 and transmitter 118. Receiver 114 receives an encoded signal and decodes the signal into a desired format. Transmitter 118 generates a broadcast signal that may include several signals at various frequencies. Those skilled in the art will recognize that there are many different types of receivers 114 and transmitters 118 available, and that for the purposes of this discussion, most receivers and transmitters may include any of these different types.

Both the receiver 114 and transmitter 118 may rely on one or more local oscillator(s) 116 such as a voltage controlled oscillator (VCO). In the case of the receiver 114, the local oscillator(s) 116 is used to lock onto an incoming signal, referred to as tuning. In the case of the transmitter 118, the local oscillator(s) is used to create a particular carrier frequency for signals to be transmitted. In the exemplary implementation, the VCO relies on one or more crystal(s) (not shown).

Antenna 112 is used as a conduit for receiving and/or transmitting communication signals. Some radios may use more than one antenna for transmitting or receiving signals. It should be recognized that antennas come in a variety of forms, and for purposes of this discussion any of these variety of forms may be included.

Radio 100 also includes a user interface and menu browser 120, and a display panel 122. The user interface and menu browser 120 allows a user of radio 100 to navigate the radio's menu structure. User interface 120 can include indicators or a series of buttons, switches, or other selectable controls that are manipulated by a user of the radio. Display panel 122 is a graphical display that provides information regarding the status of radio 100, messages, and the current options available to a user through the menu structure.

Radio 100 may include application components 124 that provide a runtime environment in which software applications or applets can run or execute. Those skilled in the art will recognize that there are many different types of runtime environments available. A runtime environment facilitates the extensibility of radio 100 by allowing various interfaces to be defined that, in turn, allow the application components 124 to interact with the radio.

Radio 100 includes one or more infrared port(s) 126 capable or receiving and/or transmitting information using one or more infrared signals. In one implementation, infrared port(s) includes a transceiver device that may include one or more Liquid Emitting Diodes (LEDs) (not shown), and/or phototransistors (not shown). It is also recognized that other components that may be capable of emitting/receiving infrared communication signals as part of infrared port 126.

General reference is made herein to one or more radios, such as radio 100. As used herein, “radio” means any programmable radio frequency communications device having data communications capabilities, and/or functions to transmit and receive waves propagated through space, wirelessly, using some type of modulation, such as, but not limited to frequency modulation, phase modulation, or amplitude modulation, to receive and transmit information. Examples of such radios can include, but are not necessarily limited to public safety communications equipment, high-end radio-telephone handsets, walkie-talkie type devices, and multi-function combination devices with wireless capabilities. Although specific examples may refer to one or more of these radios, such examples are not meant to limit the scope of the claims or the description, but are meant to provide a specific understanding of the described implementations.

It is to be appreciated that additional components can be included in radio 100 and some components illustrated in radio 100 above need not be included. For example, additional processors or storage devices, additional I/O interfaces, and so forth may be included in radio 100, or application components 124 may not be included.

It is also to be appreciated that the components and processes described herein can be implemented in software, firmware, hardware, or combinations thereof. By way of example, a digital signal processor (DSP), programmable logic device (PLD) or application specific integrated circuit (ASIC) could be configured or designed to implement various components and/or processes discussed herein.

System Environment

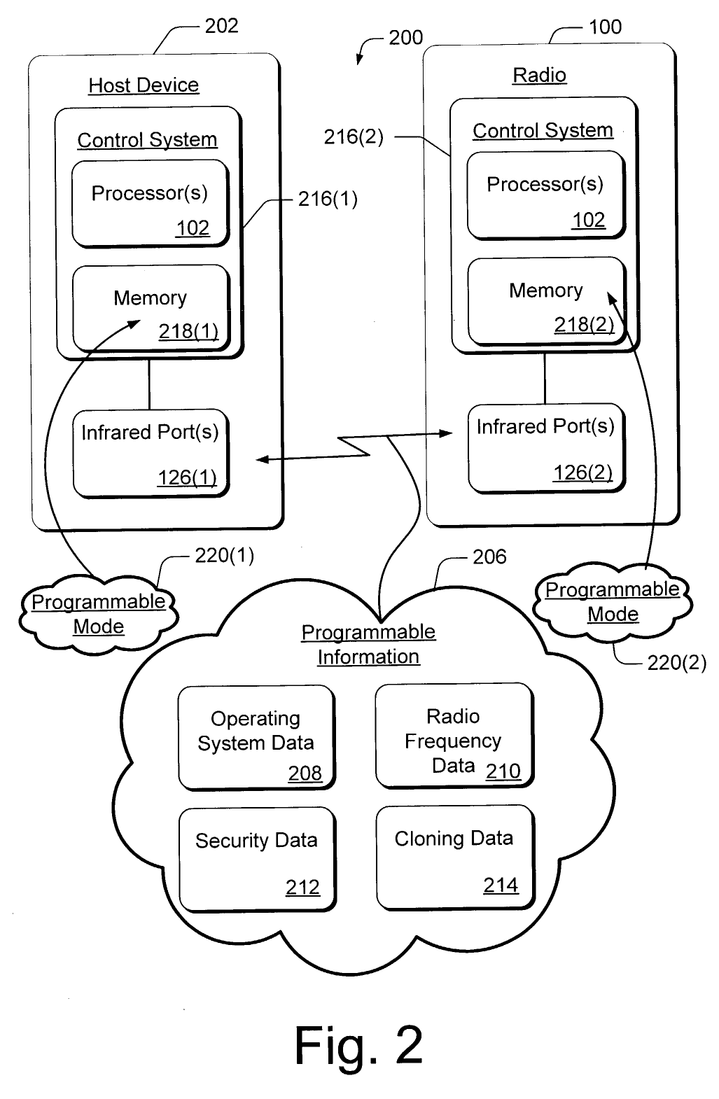

FIG. 2 illustrates select elements used in a system environment 200 in which radio 100 operates. Environment 200 also includes a host device 202, which may be a computer such as a personal computer, laptop computer, personal digital assistant (PDA), and other related devices. Host device 202 may also be another radio, such as radio 100.

Both radio 100 and host device 202 include at least one infrared port 126(1) and 126(2), respectively. Each infrared port referred to generally as reference number 126 provides infrared communications capability between host device 202 and radio 100. That is, each port 126 is equipped with an infrared transceiver port mounted on the exterior packaging of either host device 202 or radio 100, to transmit and receive data and programs using infrared signals (typically in a serial fashion).

As used herein, programs and data may also be referred to as “programmable information” 206. Programmable information may include operating system data 208, radio frequency data 210, security information 212, cloning data 214, and application components 124. Operating system data 208 may include one or more portions of an operating system 206 for radio 100 in the form of computer executable instructions, such as program modules, that can be executed by one or more processors 102 in radio 100. Generally, program modules include routines, programs, objects, components, data structures, etc. that perform particular tasks or implement particular abstract data types needed for radio 100 to operate. Radio frequency data 210 includes configurable parameters needed to enable radio 100 to operate at one or more specific frequencies. Security information 212 includes configurable parameters to enable radio 100 to encode and/or decode communication signals emitted and/or received by radio 100. Cloning data 212 includes one or more portions of programmable information 206 that enables radio 100 to copy operating characteristics of another radio. Programmable information 206 may also include other data, instructions, or programs used by radio 100 to perform operations or interoperate with other radios.

Also included in host device 202 and radio 100 are control systems 216(1) and 216(2), respectively. Control system 216(1) permits host device 202 to transmit programmable information to radio 100. In turn, control system 216(2) of radio 100 permits radio 100 to receive programmable information 206.

With respect to host device 202, control system 216(1) includes processor(s) 102, and memory 218(1) such as non-volatile memory 106 and/or firmware 110 shown in FIG. 1. Control system 216(1) controls the transfer of programmable information via infrared port 126(1) through the use of programmable logic and/or computer executable instructions stored in memory 218(1). Processor(s) 102 executes various instructions stored in memory 218(1) or in the form of firmware 110 to control the operation of host device 202 and to communicate with radio 100 via infrared port 126(1).

Control system 216(1) has a selectable programmable mode 220(1) operable to permit host device 202 to transmit the programmable information 206 to radio 100. Ultimately, this enables radio 100 to download the programmable information 206, and to function in accordance with the programmable information 206.

There are numerous ways to activate the programmable mode 220(1). For instance, the user interface and menu browser (such as 120 described with reference to FIG. 1), in communication with the control system 216(1), can select the programmable mode. As described above, user interface 120 can include buttons, keyboards, switches, or other selectable controls that are manipulated by a user of the host device 202. It is also possible that programmable mode may also be automatically selected if host device 202 receives certain activation signals from radio 100 or if an external device containing the infra red transceiver were to be attached to radio 100, thereby initiating the programmable mode. Once programmable mode 220(1) is activated, host device 202 is ready to transmit programmable information 206 to radio 100.

With respect to radio 100, control system 216(2) includes processor(s) 102, and memory 218(2) such as non-volatile memory 106 and/or firmware 110 shown in FIG. 1. Control system 216(2) controls the receipt of programmable information via infrared port 126(2) through the use of programmable logic and/or computer executable instructions stored in memory 218(2). Processor(s) 102 executes various instructions stored in memory 218(2) or in the form of firmware 110 to control the operation of radio 100 and to communicate with host device 202 via infrared port 126(2). This includes handshaking communication and/or other protocols used to communicate between two or more infrared ports.

Like control system 216(1), control system 216(2) has a selectable programmable mode 220(2) operable to permit radio 100 to receive programmable information 206. Again, there are numerous ways to activate the programmable mode 220(2) on radio 100. For instance, a user may select a button or key on user interface and menu browser 120 to activate the programmable mode 220(2). It is also possible that programmable mode 220(2) may be automatically selected if radio 100 receives certain communication signals from host device 202.

Once programmable mode 220(2) is activated, radio 100 is ready to receive programmable information 206 from host device 202 and download the programmable information 206 into memory 218(2). Once downloaded, the programmable information 206 may be used to configure or reconfigure the operational characteristics/functionality of radio 100 so that radio 100 functions in accordance with the programmable information 206.

Each control system referred to generally as reference number 216 is configurable and may be implemented as firmware, software, and/or a combination of firmware/software with hardware. In the exemplary implementation, processor 102 is a micro-controller, but may be any of the types of processors described above with reference to FIG. 1, including but not limited to: a state-machine, a DSP, an Application Specific Integrated Circuit (ASIC), or one or more processor chips. Additionally, it is to be appreciated that alternative types of computer-readable memory devices could be used for memory 218. Thus, the computer-executable instructions (including programmable logic) also could be stored on any alternative computer-readable media (RAM, Flash, etc.) including directly onto a programmable logic processor, such as a Programmable Logic Array (PLA), ASIC and other programmable processing devices. It is to be appreciated that additional components not described above can be included in either host device 202 or radio 100.

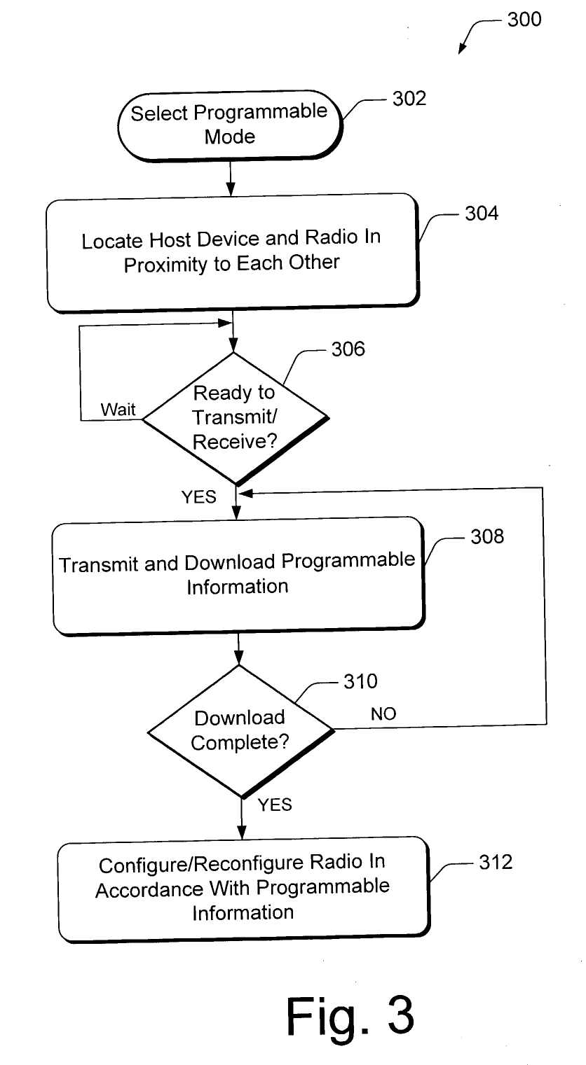

FIG. 3 is a flow chart illustrating an exemplary method 300 for configuring radio 100. More specifically, method 300 illustrates how a host device and radio function in accordance with a program mode, such as program mode 220 shown in FIG. 2. Method 300 includes blocks 302-312. The order in which the method is described is not intended to be construed as a limitation. Furthermore, the method 300 can be implemented in any suitable software, firmware, or combination thereof. In the exemplary implementation, method 300 is executed by processor(s) 102 in conjunction with the exemplary components described above.

In block 302, the programmable mode for both a host device and radio are selected. For example, in one implementation, this is accomplished by the having a user of host device 202 and/or radio 100 select programmable mode 220 through the user interface and menu browser 120.

In block 304, the radio and host device are located in proximity to each other to enable the two devices to communicate via infrared signals. It is recommended that the host device and radio be positioned a distance no farther than the maximum range infrared signals may be emitted and accurately received from either the radio or the host device. Block 304 may be performed prior to initiating method 300 and is generally a manual operation.

In a decisional block 306, a determination is made whether the host device is ready to transmit programmable information to the radio, and whether the radio is ready to receive the programmable information. If according to the “Wait” branch of decisional 306, either the radio and/or host device is not ready, then the radio and/or host device will wait until both devices are ready to receive information. For example, host device 202 and radio 100 may perform handshaking routines to ensure that both devices are ready to send and receive information.

If, according to the YES branch of decisional block 306, both devices are ready to send and receive programmable information, then according to block 308 the host device commences transmitting the programmable information to the radio. In other words, the radio will download the programmable information from the host device. For example, host device 202 will transmit programmable information 206 to radio 100 via an infrared signal(s) emitted between ports 126. In turn, radio 100 receives the programmable information, or in other words, downloads the programmable information from host device 202. Particular types of programmable information may be stored in particular files associated with the programmable information. For instance, radio frequency data may be stored in a radio frequency file (not shown) etc.

In decisional block 310, a decision is made when the downloading of programmable information is completed. According to the NO branch of decisional block 310, operations performed in block 308 shall continue until all programmable information has been downloaded. Unless prematurely interrupted, downloading of programmable information shall continue until all the programmable information intended be transferred from the host device is received by the radio. According to the YES branch of decisional block 310, when all programmable information needed to be sent during a configuration session has been sent and received, then a download is considered successfully completed. Handshaking between the host device and radio may provide an indication when a download complete.

In one implementation, the transfer of programmable information is performed in a half-duplex manner, first transmitting and then receiving confirmation of correct reception. The transfer of information, however, may be sent quicker without the need for confirmations. For added security it is also possible to encode the infrared signal(s) carrier signal between the infrared ports. For example, suppose that host device 202 is transferring security data 212 in the form of encryption key data to radio 100 in the field. It may be desirous to encrypt the infrared signal between host device 202 and radio 100 when sending such sensitive data to avoid comprising the security of radio 100.

According to block 312, radio 100 switches out of the programmable mode to a normal operation mode. The normal operation mode (not shown) may rely on programmable information recently downloaded from host device 202. For example, when programmable mode 220(2) of radio 100 is switched off, a normal mode of operation is selected for radio 100. This may be performed manually or automatically. Switching out of the programmable mode prevents possible corruption of the radio's operating system from occurring. At this point, radio 100 may be initialized (e.g., powered-off and on) to reset buffers in memory 218(2) with new functionality or data prescribed by the programmable information 206. Radio 200 is now capable of operating in accordance with the programmable information 206.

Although some implementations of the various methods and arrangements of the present invention have been illustrated in the accompanying Drawings and described in the foregoing Detailed Description, it will be understood that the invention is not limited to the exemplary aspects disclosed, but is capable of numerous rearrangements, modifications and substitutions without departing from the spirit of the invention as set forth and defined by the following claims.

What is claimed is:

1. A radio, comprising:
an infrared port configured to receive programmable information from a host device via an infrared signal; and
a control system having a selectable programmable mode to enable the radio to download the programmable information from the host device and configure the radio to function in accordance with the programmable information.

2. The radio as recited in claim 1, wherein the programmable information includes computer executable instructions that collectively form one or more portions of an operating system.

3. The radio as recited in claim 1, wherein the programmable information includes radio frequency data to enable the radio to operate at one or more specific frequencies.

4. The radio as recited in claim 1, wherein the programmable information includes security information to enable the radio to encode and/or decode communication signals emitted and/or received by the radio.

5. The radio as recited in claim 1, wherein the programmable information includes cloning data to enable the radio to copy operating characteristics of another radio.

6. The radio as recited in claim 1, further including a memory device configured to store the programmable information.

7. The radio as recited in claim 1, wherein the host device is a radio also having an infrared port.

8. The radio as recited in claim 1, wherein the host device is a personal computer having an infrared port.

9. The radio as recited in claim 1, wherein the programmable mode is selected by a user interface.

10. A radio, comprising:
an infrared port configured to transmit programmable information via an infrared signal; and
a control system having a programmable mode operable to permit the radio to transmit the programmable information to another radio to enable the other radio to download the programmable information and function in accordance with the programmable information.

11. The radio as recited in claim 10, wherein the programmable information includes computer executable instructions that collectively form one or more portions of an operating system.

12. The radio as recited in claim 10, wherein the programmable information includes radio frequency information to enable the other radio to operate at one or more specific frequencies.

13. The radio as recited in claim 10, wherein the programmable information includes security information to enable the other radio to encode and/or decode communication signals emitted and/or received by the other radio.

14. The radio as recited in claim 10, wherein the programmable information includes cloning data to enable the other radio to copy operating characteristics associated with the radio.

15. One or more computer-readable media having stored thereon computer executable instructions that, when executed by one or more processors, causes the one or more processors of a radio to: receive programmable information from an infrared port; and configure the radio to function in accordance with the programmable information received from the infrared port.

16. One or more computer-readable media as recited in claim 15, wherein the information includes operating system data.

17. One or more computer-readable media as recited in claim 15, wherein the information includes radio frequency information to enable the radio to operate at one or more specific frequencies.

18. One or more computer-readable media as recited in claim 15, wherein the information includes security information to enable the radio to encode and/or decode communication signals emitted and/or received by the radio.

19. One or more computer-readable media as recited in claim 15, wherein the information includes cloning data to enable the radio to copy operating characteristics of another radio.
